(19) United States
(12) Patent Application Publication
(10) Pub. No.: US 2026/0154265 A1
(43) Pub. Date: Jun. 4, 2026

(54) METHOD FOR SUPPORTING LIGHTWEIGHT VECTOR SEARCH IN VECTOR DATABASE AND APPARATUS THEREOF

(71) Applicants: D.notitia.Inc., Seongnam-si (KR); UNIVERSITY-INDUSTRY COOPERATION GROUP OF KYUNG HEE UNIVERSITY, Yongin-si (KR)

(72) Inventors: Moo Hyeon NAM, Seoul (KR); Hong Chan Roh, Seoul (KR); Se Hyun Yang, Seoul (KR); Mao Kyoung Chung, Seoul (KR); Seung Kyu Choi, Yongin-si (KR); Seong Joon Cho, Yongin-si (KR)

(73) Assignees: D.notitia.Inc., Seongnam-si (KR); UNIVERSITY-INDUSTRY COOPERATION GROUP OF KYUNG HEE UNIVERSITY, Yongin-si (KR)

(21) Appl. No.: 19/404,571

(22) Filed: Dec. 1, 2025

(30) Foreign Application Priority Data
Nov. 29, 2024 (KR) 10-2024-0174312

(51) Int. Cl. G06F 16/2453; G06F 16/22

(52) U.S. Cl. CPC G06F 16/24542; G06F 16/2237

(57) ABSTRACT

Provided is a method of storing a vector in a server providing a vector DB system. The method of storing a vector includes slicing a 16-bit vector into an upper 8-bit MSB block and a lower 8-bit LSB block, rounding the MSB block by reflecting information of the LSB block to the MSB block, and storing the rounded MSB block and the LSB block.

### CROSS-REFERENCE TO RELATED APPLICATIONS

This application claims priority under 35 U.S.C. § 119 to Korean Patent Application No. 10-2024-0174312 filed on Nov. 29, 2024, in the Korean Intellectual Property Office, the disclosures of which are incorporated by reference herein in their entireties.

### BACKGROUND

Embodiments of the present disclosure described herein relate to a method for supporting lightweight vector search in a vector database to efficiently use hardware resources while maintaining search precision, and an apparatus thereof.

A vector database refers to a database obtained by representing and storing data objects as high-dimensional vectors. Specifically, the vector database measures the similarity between vectors to support similarity-based search. Complex data such as images, text, and audio may be mapped into a high-dimensional vector space by using the vector DB so as to be represented. The high-dimensional vectors are typically generated through machine learning or deep learning models and have the characteristic of placing semantically similar data items close together.

A vector similarity search refers to a process of finding a vector similar to a given query vector in a vector database. Cosine similarity, Euclidean distance, and dot product may be used as a method for measuring similarity between vectors. Through this similarity measurement method, vectors closest to the query vector may be efficiently found, and the results may be returned.

The vector similarity search is utilized in a variety of applications, such as an image search, a document search, a recommendation system, and Natural Language Processing (NLP). However, as a vector dimension increases, the computational complexity increases and memory and processing power are required. Accordingly, lightweight techniques capable of improving search efficiency and maintaining the precision of the vector search at the same time may be considered.

Korean Patent Publication No. 2023-0077251 (Publication date: June 1, 2023) as a related document.

### SUMMARY

Embodiments of the present disclosure provide a vector storage structure capable of light-weighting a vector search in a vector database.

Embodiments of the present disclosure provide a search method capable of reducing resources of the vector search while maintaining precision.

Problems to be solved by the present disclosure are not limited to the above-described problem, and other problems not mentioned herein may be clearly understood from this specification and the accompanying drawings by those skilled in the art to which the present disclosure pertains.

According to an embodiment, a method of storing a vector in a server providing a vector database (DB) system includes slicing a 16-bit vector into an upper 8-bit More Significant Bits (MSB) block and a lower 8-bit Least Significant Bits (LSB) block, rounding the MSB block by reflecting information of the LSB block to the MSB block, and storing the rounded MSB block and the LSB block.

According to an embodiment, a method of calculating a vector in a server providing a vector DB system includes searching for a candidate node similar to the query vector in a pre-stored vector index when a 16-bit query vector is received, calculating first similarity between the query vector and an upper 8-bit MSB block of the candidate node, and returning the first similarity as similarity of a candidate node after a predetermined number of hops in the vector index.

According to an embodiment, a method of calculating a vector in a server providing a vector DB system includes extending a dimension of the query vector by a preset number of an important dimension and recording content of the important dimension in an extended dimension block when a 16-bit query vector is received, and calculating first similarity between the query vector and an upper 8-bit MSB block of a candidate node with respect to a dimension, of which a flag bit is not marked, from among dimensions of the candidate node.

According to an embodiment, a vector storage apparatus in a vector DB system includes a processing unit that slices a 16vector into an upper 8-bit MSB block and a lower 8-bit LSB block and rounds the MSB block by reflecting information of the LSB block to the MSB block, and a memory that stores the rounded MSB block and the LSB block.

According to an embodiment, an apparatus calculating a vector in a vector DB system includes a control unit that schedules, when a 16-bit query vector is received, a search task for a candidate node similar to the query vector from a pre-stored vector index, and a vector processing unit that calculates first similarity between the query vector and an upper 8-bit MSB block of the candidate node, and returns the first similarity as similarity of a candidate node after a predetermined number of hops in the vector index.

According to an embodiment, an apparatus calculating a vector in a vector DB system includes a control unit that extends, when a 16-bit query vector is received, a dimension of the query vector by a preset number of an important dimension and to record content of the important dimension in an extended dimension block, and a vector processing unit that calculates first similarity between the query vector and an upper 8-bit MSB block of a candidate node with respect to a dimension, in which a flag bit is not marked, from among dimensions of the candidate node.

Solutions to the problem of the present disclosure are not limited to the above-described solution, and solutions not mentioned herein may be clearly understood from this specification and the accompanying drawings by those skilled in the art to which the present disclosure pertains.

### BRIEF DESCRIPTION OF THE FIGURES

The above and other aspects of the present disclosure will become apparent to those of ordinary skill in the art by describing exemplary embodiments thereof in detail with reference to the accompanying drawings.

FIG. 1 is a flowchart for describing a process, in which a user processes and searches for data by using a vector DB system, according to an embodiment of the present disclosure.

FIG. 2 is a block diagram for describing a structure of vector search-dedicated hardware in a vector DB system, according to an embodiment of the present disclosure.

FIGS. 3A and 3B are diagrams for describing a query search method and a vector index structure generated according to an embodiment of the present disclosure.

FIG. 4 illustrates an experimental diagram of a traversal process of a graph-based vector index structure.

FIG. 5 is a flowchart illustrating a method for storing 16-bit vector data according to an embodiment of the present disclosure.

FIG. 6 is a diagram for describing an example of storing 16-bit vector data, according to an embodiment of the present disclosure.

FIG. 7 is a flowchart illustrating a method for performing a vector search in a vector DB system, according to an embodiment of the present disclosure.

FIG. 8 is a diagram for describing an example of a lightweight vector search, according to an embodiment of the present disclosure.

FIG. 9 is a graph showing the absolute maximum value of data in each dimension in a large high-dimensional dataset.

FIG. 10 is a flowchart illustrating a method for storing 16-bit vector data for each dimension, according to an embodiment of the present disclosure.

FIG. 11 is a diagram for describing an example of storing 16-bit vector data by reflecting the importance of a dimension, according to an embodiment of the present disclosure.

FIG. 12 is a flowchart illustrating a method for performing a lightweight vector search by reflecting the importance of a dimension in a vector DB system, according to an embodiment of the present disclosure.

FIG. 13 is a diagram illustrating an example of a vector search light-weighted by reflecting importance of a dimension, according to an embodiment of the present disclosure.

FIG. 14 is a diagram for describing a computing operating environment of a server providing a vector DB system, according to one embodiment of the present disclosure.

### DETAILED DESCRIPTION

Hereinafter, the preferred embodiments of the present disclosure are described with reference to the accompanying drawings.

However, embodiments of the present disclosure may be modified in the different forms, and the scope and spirit of the present disclosure is not limited by the embodiments to be described below. Furthermore, embodiments of the present disclosure are provided to more fully describe the present disclosure to those skilled in the art to which the present disclosure pertains.

In other words, the aforementioned objectives, features, and advantages will be described in detail below with reference to the accompanying drawings, and accordingly, those skilled in the art to which the present disclosure pertains may readily implement the technical concept of the present disclosure. In describing the present disclosure, when detailed descriptions of prior art related to the present disclosure is determined to be deemed to unnecessarily obscure the essence of the present disclosure, the detailed descriptions are omitted. Hereinafter, a preferred embodiment according to the present disclosure will be described in detail with reference to the accompanying drawings. In the drawings, the same reference numerals are used to indicate the same or similar components.

Moreover, expressions in the singular used herein include expressions in the plural unless interpreted otherwise in context. In this specification, terms such as “comprises” or “includes” should not be interpreted that a plurality of components or a plurality of steps described herein are necessarily included, and should be interpreted that some components thereof or some steps thereof are omitted, or additional components or steps are further included.

Furthermore, various components and their subcomponents are described below to describe a system according to an embodiment of the present disclosure. These components and their subcomponents may be implemented in various forms, such as hardware, software, or any combination thereof. For example, each element may be implemented as an electronic configuration for perform the corresponding function, as software itself that may be executed on an electronic system, or as a functional element of the software. Alternatively, it may be implemented as an electronic configuration and operating software corresponding thereto.

The various techniques described herein may be implemented with hardware or software, or with a combination of both where appropriate. Terms such as a “unit,” a “server,” and a “system” as used herein may similarly be treated as equivalent to computer-related entities, namely hardware, a combination of hardware and software, software, or software in execution. Also, each function executed in the system according to an embodiment of the present disclosure may be configured in units of module and may be recorded in a single physical memory or distributed and recorded across two or more memories and recording media.

Although being disclosed to describe embodiments of the present disclosure, various flowcharts are provided for the convenience of describing each step and do not necessarily mean that each step is performed in the order shown in the flowcharts. That is, steps in a flowchart may be performed simultaneously, in the order according to the flowchart, or even in the reverse order of the flowchart.

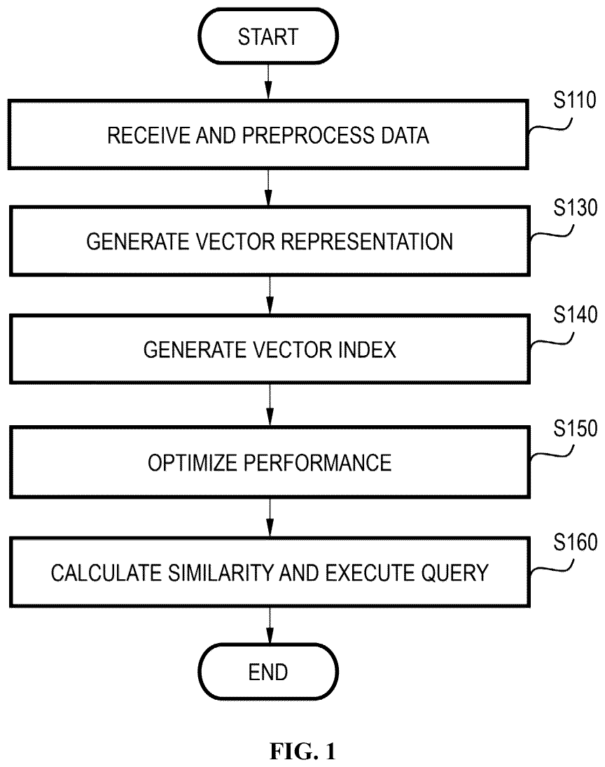

FIG. 1 is a flowchart for describing a process, in which a user processes and searches for data by using a vector DB system, according to an embodiment of the present disclosure.

In operation S110 of FIG. 1, a vector DB system may receive data from a user. The data may include both structured data and unstructured data. The vector DB system may assign a tenant for the user and may refine the data by performing duplication removal, normalization, and cleansing.

In operation S130 of FIG. 1, the vector DB system may generate and store a vector representation of the received data by using an embedding model. Vector embedding may be defined as representing unstructured data and/or structured data such as text, images, voice, tables, and graphs, in a multi-dimensional vector space by reflecting data characteristics. This enables the measurement of semantic similarity among data. The vector embedding may be performed in various ways, and the present disclosure should not be interpreted as limited to any specific method. For example, the vector representation may be extracted through an embedding model provided by the vector DB system. In another example, the vector representation may be extracted from an external embedding model linked to the vector DB system, not the embedding model provided by the vector DB system.

In operation S140 of FIG. 1, the vector DB system may generate and store an index for the vector representation of the data. The vector index is a data structure for quickly performing a similarity search between vectors. The vector index may be applied to a structure that hashes similar vectors into the same bucket, and a structure that hierarchically connects vectors with high similarity as a graph-based structure.

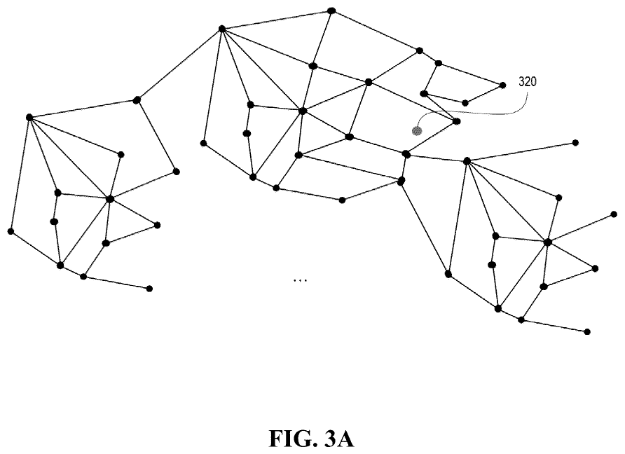

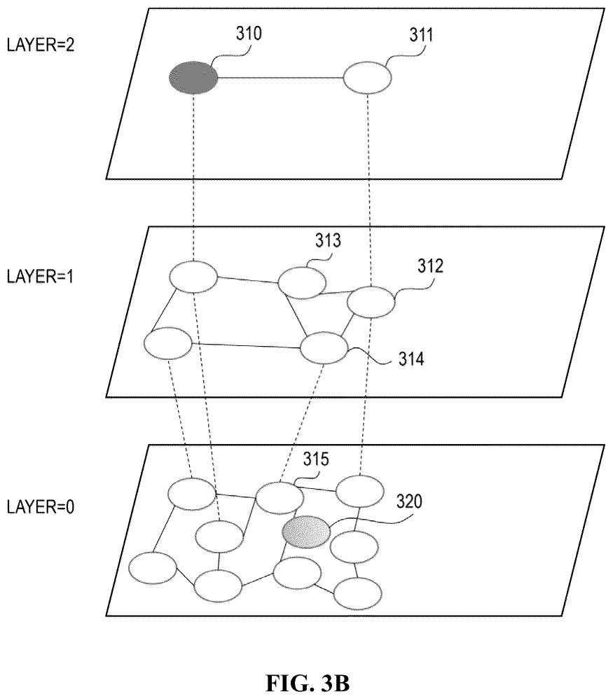

For example, a vector DB according to an embodiment of the present disclosure may generate a vector index by using a graph including a node representing a feature value of a data point in enterprise data and an edge representing the relationship between a plurality of nodes. In the case, the graph may be formed to have a hierarchical structure. For example, the hierarchical structure may be formed by forming a plurality of layers, forming all nodes in the bottom layer, and forming fewer nodes as it goes to an upper layer. The vector index structure according to an embodiment of the present disclosure will be described later in the descriptions of the attached FIGS. 3A and 3B.

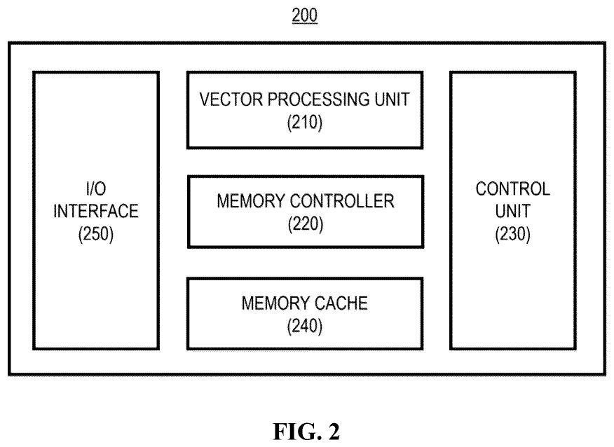

In the meantime, in operation S150 of FIG. 1, the vector DB system may perform performance optimization to efficiently search for stored vector data and vector indexes. For example, the vector DB system may include vector search-dedicated hardware to reduce CPU usage and to shorten a search time by processing large-scale vector operations in parallel. The vector DB system may efficiently perform distributed storage, clustering, and caching as well as parallel processing of vector data by using the vector search-dedicated hardware, thereby improving overall system efficiency. The structure of the vector search-dedicated hardware according to an embodiment of the present disclosure will be described later in the description of the attached FIG. 2.

In operation S160 of FIG. 1, when a query of a user is received, the vector DB system may express the query as a vector value by applying the query to the vector embedding model, may calculate a vector index for a query vector, and may search for and return vectors with high similarity. Cosine similarity or Euclidean distance may be used to calculate similarity between vectors.

For example, a method of comparing a query vector with all data points to calculate respective distances, and generating a candidate dataset sorted by proximity may be considered as a vector search method. This method is highly accurate but slow. Accordingly, a nearest neighbor search may be considered to provide a balance between search speed and search quality. In the vector DB, a nearest neighbor search algorithm is used to quickly find a neighboring vector close to a query vector in high-dimensional data. The method of calculating the similarity between the query vector and all data points has high accuracy but has a slow search speed. Accordingly, the nearest neighbor search algorithm may provide the compromise between accuracy and speed in vector search. The nearest neighbor search according to an embodiment of the present disclosure will be described below with reference to the attached FIGS. 3A and 3B.

Afterwards, the vector DB system may return the query results and may complete the process. In the case, the vector DB system may output the results to a user interface and may further perform result filtering and sorting operations.

FIG. 2 is a block diagram for describing a structure of vector search-dedicated hardware in a vector DB system, according to an embodiment of the present disclosure.

A vector search-dedicated hardware 200 according to an embodiment of the present disclosure is designed to process vector operations at high speed and to maximize the efficiency of a vector similarity search. The vector search-dedicated hardware 200 may include a vector processing unit 210, a memory controller 220, a control unit 230, a memory cache 240, and an I/O interface 250.

The vector processing unit 210 of FIG. 2 may perform high-speed calculations on large amounts of vector data through parallel processing. Vector calculations for a similarity search between a query vector and a DB vector are designed to calculate a distance such as cosine similarity distance and Euclidean distance. The vector processing unit 210 corresponds to a module optimized for high-dimensional vector operations.

The memory controller 220 of FIG. 2 may store vector data in storage and may manage memory access for reading vector data stored in the storage. The memory controller 220 features a high-bandwidth memory interface to minimize data transfer bottlenecks occurring during operations and to optimize computation speed.

The control unit 230 of FIG. 2 may control an operation of the vector search-dedicated hardware 200. The control unit 230 may schedule vector search tasks and may manage workflows between the vector processing unit 210, the memory controller 220, and the I/O interface 250. In more detail, the control unit 230 adjusts task priorities and ensures the stability and efficiency of the system.

The memory cache 240 of FIG. 2 may temporarily store frequently used vector data to increase memory access speed. The memory cache 240 minimizes data access latency through a multilevel cache (e.g., L1 cache, L2 cache, etc.) and supports fast access to data repeatedly referenced during calculations.

The I/O interface 250 of FIG. 2 may process data input/output between an external data source and hardware. The I/O interface 250 supports various interfaces, such as Peripheral Component Interconnect Express (PCIe) and Ethernet, for high-speed data transmission and processes large-scale vector data in real time to integrate the processed result with a database.

The vector search-dedicated hardware 200 illustrated in FIG. 2 is a dedicated hardware configuration designed to optimize vector operations by providing a high-performance and high-efficiency vector data processing environment, thereby effectively increasing the efficiency of vector data processing and maximizing similarity search performance.

FIGS. 3A and 3B are diagrams for describing a query search method and a vector index structure generated according to an embodiment of the present disclosure.

As illustrated in FIGS. 3A and 3B, a vector index structure according to an embodiment of the present disclosure may be represented as a graph including a node representing a characteristic value of a data point and an edge representing relationships between a plurality of nodes. In the case, a graph may be formed as a planar structure, as illustrated in FIG. 3A, or may be formed as a hierarchical structure, as illustrated in FIG. 3B.

When a vector index according to an embodiment of the present disclosure is formed in a hierarchical structure, as shown in layer 0 of FIG. 3B, layer 0 being a bottom layer may include all nodes for data points and be configured by connecting only similar nodes with a horizontal edge. Furthermore, as shown in layer 1 of FIG. 3B, layer 1 being an upper layer of layer 0 may be formed by probabilistically extracting some nodes from layer 0 and connecting similar nodes among the extracted nodes with a horizontal edge. Likewise, layer 2 being an upper layer of layer 1 may be formed by probabilistically extracting some nodes from layer 1 and connecting similar nodes among the extracted nodes with a horizontal edge. The vector index structure according to an embodiment of the present disclosure may be formed to have a hierarchical structure by extracting fewer nodes as it goes to an upper layer and connecting nodes in a lower layer with similar relationships to nodes in an upper layer by using a vertical edge.

Meanwhile, when a query vector 320 is input as in examples of FIG. 3A or 3B, according to an embodiment of the present disclosure, nodes similar to the query vector 320 may be quickly found by using a vector index of FIG. 3A or a vector index of FIG. 3B. In more detail, when operations are repeated to move to a node closest to a start node by calculating a distance between the start node and each of its neighboring nodes, starting from the start node, and to move to a node closest to the corresponding node by calculating a distance between the corresponding node and each of its neighboring nodes based on the moved node, a node closest to the query vector 320 may be found quickly.

In the case, when the vector index has a hierarchical structure, as shown in FIG. 3B, a search begins at a start node 310 of layer 2 being a top layer, and then moves to a node 311 closest to the query node 320. Next, when being incapable of getting closer to the query node 320 from the node 311, it may move to a node 312 of layer 1 being a lower layer of layer 2 connected to the node 311. Next, it moves from the node 312 to a node 314 that is close to the query node 320. Next, when being incapable of getting closer to the query node 320 from the node 314, it may move to a node 315 of layer 0 being a lower layer of layer 1 connected to the node 314. The node 315 closest to the query node 320 may be quickly found by repeating this process until the closest node to the query node 320 is reached.

This search method is known as an Approximate Nearest Neighbor (ANN) index search, which enables an efficient search of the nearest data in high-dimensional data. In the ANN index search, vector similarity may be typically calculated by using an angle-based cosine similarity algorithm or a Euclidean distance-based Euclidean similarity algorithm.

In the meantime, large-scale datasets have exploded in growth in modern times, and high-dimensional vectors are primarily used to represent complex data more accurately. These changes have led to a rapid increase in the size of a vector DB, thereby making high memory bandwidth the primary bottleneck. In particular, as the volume of data increases, the bottleneck may have a more critical impact on performance degradation.

To address this issue, the vector database system according to an embodiment of the present disclosure may apply a lightweight technique that reduces the number of bits in a search data. In particular, according to an embodiment of the present disclosure, the bottleneck in the vector search is alleviated by reducing the number of bits in the search data, and at the same time, the precision of a vector search changes in consideration of the distribution of the dataset.

In more detail, the vector DB system according to an embodiment of the present disclosure may slice a 16-bit vector into an upper 8-bit block and a lower 8-bit block so as to be stored. In the case, the upper 8-bit block represents more pieces of information than the lower 8-bit block, and is referred to as a “More Significant Byte (MSB) block”. The lower 8-bit block represents less pieces of information than the upper 8-bit block, and is referred to as a “Less Significant Byte (LSB) block”. That is, according to an embodiment of the present disclosure, the 16-bit vector may be stored by slicing it into an MSB block and an LSB block.

Hereinafter, the vector DB system according to an embodiment of the present disclosure may calculate both the MSB block and the LSB block when a precise search is required, and may calculate only the MSB block when precise search is not required, thereby reducing the computational burden of vector calculations and alleviating bottlenecks in a vector search. A method of storing and searching for vectors according to an embodiment of the present disclosure will be described later with reference to the accompanying drawings.

To apply a lightweight vector search method according to an embodiment of the present disclosure to the vector DB system, there is an issue on the classification between a case where both the MSB block and the LSB block are searched (i.e., a case where search precision is required), and a case where the MSB block is searched (i.e., a case where search speed is more important than search precision).

In a graph-based vector index structure such as FIGS. 3A and 3 B, a vector search in the vector DB system will be performed through a traverse, which is a search process of searching for the nearest neighbor for the query vector 320 while moving along a graph starting from a start node (i.e., an entry point). However, when the number of hops exceeds a certain threshold in the traverse process, a phenomenon that search efficiency is saturated may occur, and this may be experimentally verified. The saturation of search efficiency refers to a state where additional searches do not significantly improve the accuracy of the vector search. Considering this state, it is identified that the precise search is no longer necessary from a point in time when the search efficiency reaches saturation, and increasing hit probability through the precise search is a more efficient search strategy before the search efficiency saturation occurs.

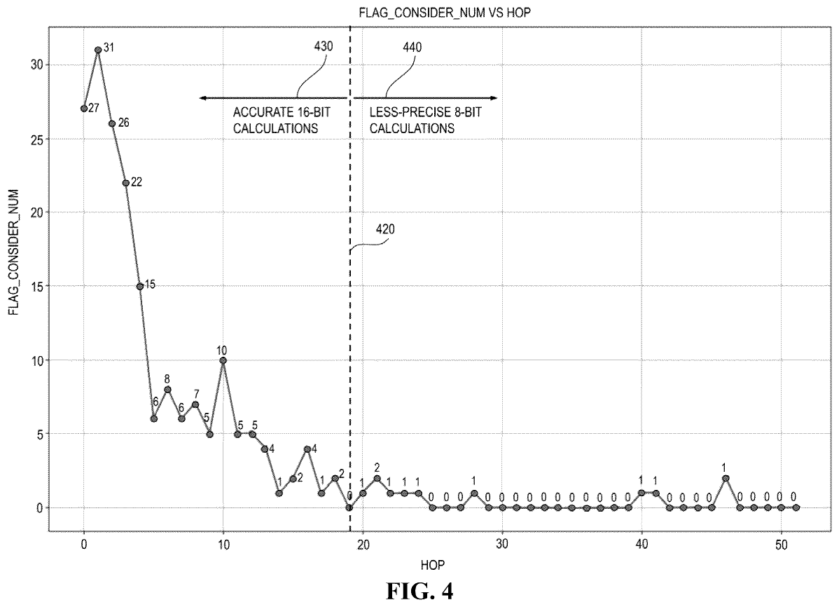

FIG. 4 illustrates an experimental diagram of a traversal process of a graph-based vector index structure. An x-axis in FIG. 4 represents the number of hops passed by a search traverse, and a y-axis represents the number of similar nodes additionally found at the corresponding hop during the search traverse.

Referring to FIG. 4, it may be identified that no further similar nodes are found even when additional hops are found (i.e., search precision does not increase) based on a reference numeral 420 in FIG. 4. It may be identified that searches before 19 hops of the reference numeral 420 are highly important in the overall search process in the experiment in FIG. 4. The reason is likely that the overall search efficiency becomes extremely low when errors in setting the search path occur because search precision is lowered during the early traverse.

Considering this tendency, the vector search method according to an embodiment of the present disclosure may prioritize search precision during the early traverse to search for both an MSB block and a LSB block (430), and prioritizes search speed over search precision during the late traverse to search for only the MSB block (440), thereby reducing the number of bits in vector data and alleviating the bottleneck in the vector search.

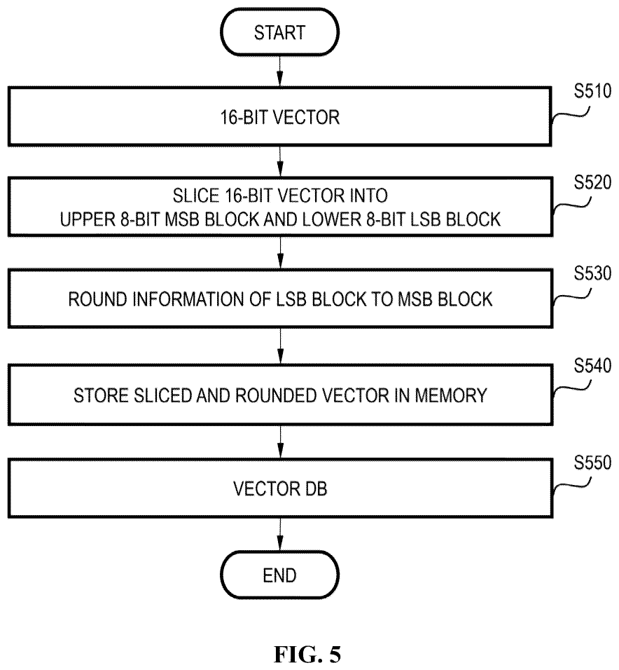

FIG. 5 is a flowchart illustrating a method for storing 16-b it vector data according to an embodiment of the present disclosure.

In the example of FIG. 5, a vector DB system according to an embodiment of the present disclosure may receive a 16-bit vector (S510) and may slice the 16-bit vector into an upper 8-bit MSB block and a lower 8-bit LSB block (S520).

In this case, simply discarding the lower 8 bits and using only the upper 8 bits to increase the speed of vector search may result in errors due to information loss. To prevent this, the vector DB system may improve the accuracy of a search by reflecting information of the LSB block to the MSB block through rounding (S530).

The rounding is a method for adjusting the MSB block in consideration of information of the LSB block. Even when only the MSB block is used during a vector search by minimizing information loss through the rounding, a closer approximate value of the full value of the 16-bit vector may be obtained.

Afterwards, the vector DB system may store the sliced and rounded vector in a memory (S540). In detail, the vector DB system may store the sliced LSB block and the MSB block, which is sliced and in which information of the LSB block is rounded, in the memory. In this case, the memory address space of the MSB block and the memory address space of the LSB block may be separated from each other.

Through this process, the vector DB system may configure a vector DB (S550).

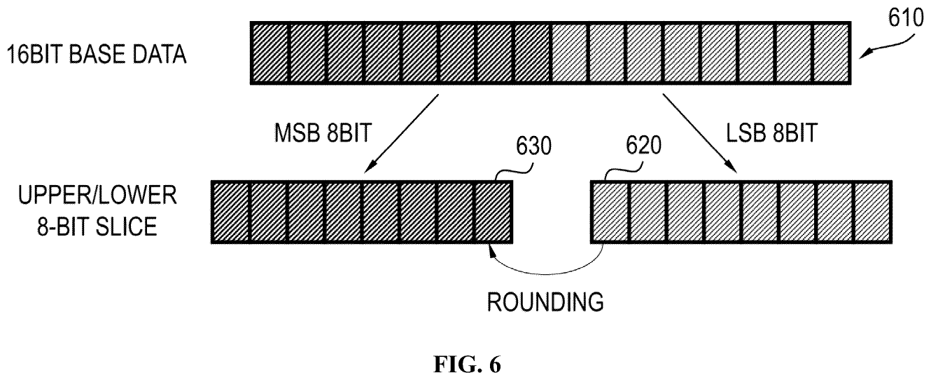

FIG. 6 is a diagram for describing an example of storing 16-bit vector data, according to an embodiment of the present disclosure.

In the example of FIG. 6, a 16-b it vector 610 may be sliced into an MSB block with upper 8 bits and an LSB block with lower 8 bits. In this case, information of most significant bit (MSB) 620 of the LSB block, which includes the most pieces of information, may be reflected to least significant bit (LSB) 630 of the MSB block. For example, the value of the MSB 620 of the LSB block may be added to the LSB 630 of the MSB block to round information of the LSB block to the MSB block. For example, when the value of the MSB 620 in the LSB block is 1, 1 is added to the LSB 630 of the MSB block. When the value of the MSB 620 in the LSB block is 0, the value of the LSB 630 in the MSB block remains unchanged. In other words, according to an embodiment of the present disclosure, the value of the MSB 620 of the LSB block may be added to the LSB 630 of the MSB block so as to be rounded.

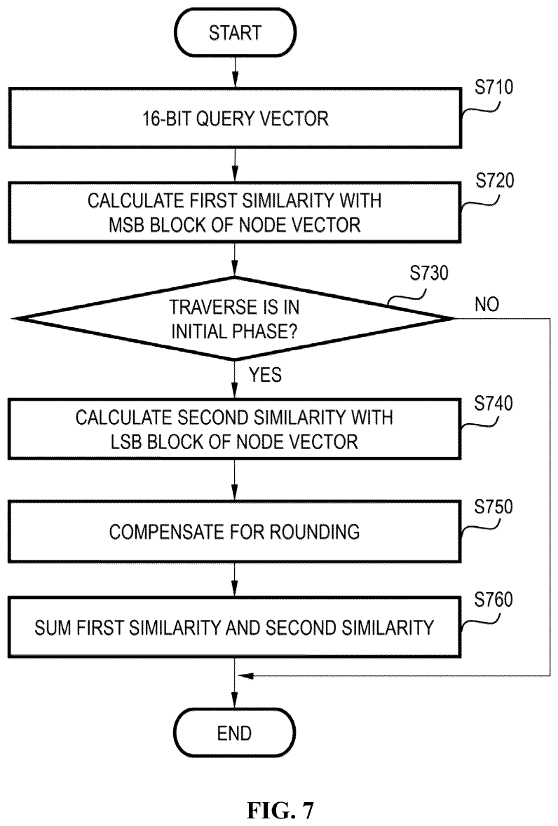

FIG. 7 is a flowchart illustrating a method for performing a vector search in a vector DB system, according to an embodiment of the present disclosure.

When a 16-bit query vector is received by a vector DB system according to an embodiment of the present disclosure (S710), in a graph-based vector index structure, a traverse that is a search process of searching for a similar node for a query vector while moving along a graph from an entry point may be performed.

In the case, in calculating the similarity between the query vector and candidate nodes found during a traverse process, the vector DB system may reduce computational load and may increase vector search speed by calculating the first similarity between the query vector and an MSB block of a node vector (S720).

In the case, the MSB block of the node vector corresponds to the upper 8 bits of the node vector, and thus the vector DB system may convert the MSB block into a 16-bit format by shifting the MSB block to the left by 8 bits. Because the values of the lower 8 bits of the 16-bit MSB block shifted to the left are 0, the vector DB system may calculate the first similarity with the query vector by using only information of the upper 8 bits of the 16-bit MSB block.

In the meantime, as described above, the vector search method according to an embodiment of the present disclosure may calculate the similarity with the query vector with respect to both the MSB block and the LSB block because prioritizing search precision during the early traverse, and may calculate the similarity with the query vector with respect to only the MSB block because prioritizing search speed over search precision during the late traverse, thereby reducing computational load and alleviating the bottleneck in the vector search.

Accordingly, the vector DB system may determine whether the traverse is in an initial phase after operation S720 (S730).

When the determination result of S730 indicates that the traverse is in an initial phase (S730, YES), the vector DB system may calculate second similarity between the query vector and the LSB block of the node vector, may compensate for the rounded information, may add the first similarity and the second similarity, and may return the result as the similarity calculation result (S740 to S760).

In particular, because the LSB block of the node vector corresponds to the lower 8 bits of the node vector, no shift is necessary when the LSB block of the node vector is converted to a 16-bit format. Because the values of the upper 8 bits of the 16-bit LSB block are 0, the vector DB system may calculate the second similarity with the query vector with respect to information of the lower 8 bits of the 16-bit LSB block (S740).

In the meantime, in the vector DB system according to an embodiment of the present disclosure, the node vector may be stored in a form where information of the LSB block of the node vector is reflected to the MSB block of the node vector (i.e., in a rounded form). In this case, in a precise search of calculating the second similarity between the query vector and the LSB block of the node vector, it is necessary to initially compensate for the rounded information (S750).

For example, when the MSB of the LSB block of the node vector is 1, the vector DB system may reflect and store the corresponding information to the LSB of the MSB block of the node vector. Accordingly, in a precise search that calculates the second similarity between the query vector and the LSB block of a node vector, in a case where the MSB of the LSB block of the node vector is 1, the case indicates that the rounded information is present. Accordingly, the second similarity with the query vector may be calculated by subtracting 2⁸ from the LSB block of the node vector. In a case where the MSB of the LSB block of the node vector is 0, the case indicates that the rounded information is not present. Accordingly, the similarity with the query vector may be calculated by using the 8-bit LSB block as is.

Afterwards, at the beginning of a traverse where a precise search is important, the vector DB system may sum the first similarity between the query vector and the MSB block of the node vector, and the second similarity between the query vector and the LSB block of the node vector (S760), and may return the result as the similarity calculation result.

In the meantime, when the determination result of operation S730 is that the traverse is in a latter half (S730, NO), the vector DB system may return only the first similarity between the query vector and the MSB block of the node vector calculated in S720 as the similarity calculation result.

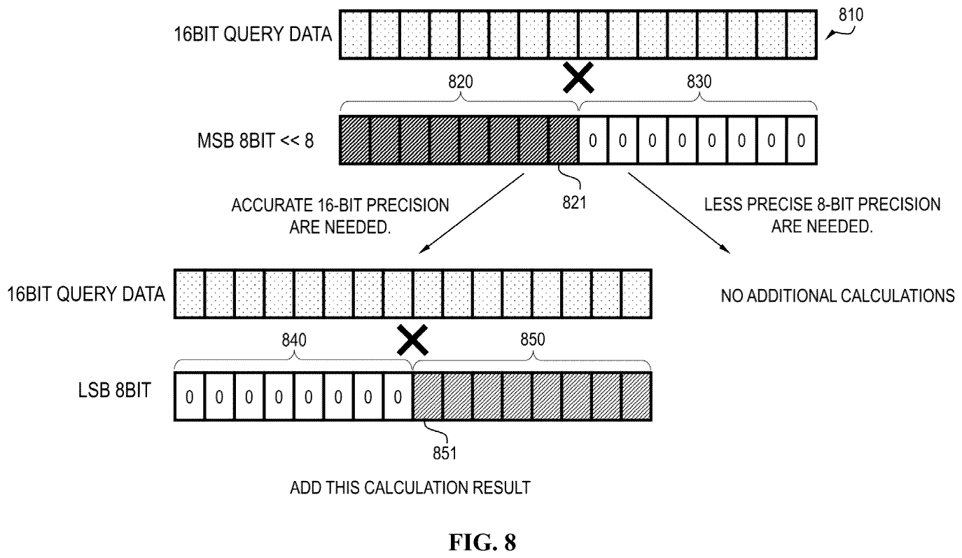

FIG. 8 is a diagram for describing an example of a lightweight vector search, according to an embodiment of the present disclosure.

Referring to FIG. 8, when a 16-bit query vector 810 is received by the vector DB system, the vector DB system may calculate first similarity with the query vector with respect to only the MSB block 820 of a node vector in calculating the similarity between the query vector 810 and the node vector, thereby reducing the computational burden and increasing the vector search speed.

Because the MSB block 820 of the node vector corresponds to the upper 8 bits of the node vector, as illustrated in FIG. 8, the MSB block 820 of the node vector may be changed to a 16-bit format by being shifted to the left by 8 bits. The values of the lower 8 bits 830 among the 16-bit MSB block (820 and 830) are 0. The first similarity between the query vector 810 and the 16-bit MSB blocks 820 and 830 may be calculated.

However, when a precise search is required (e.g., at the beginning of the traverse), the second similarity between the query vector and a LSB block 850 of the node vector needs to be reflected to the search. In detail, because the LSB block 850 of the node vector corresponds to the lower 8 bits of the node vector, the LSB block 850 of the node vector may be changed to a 16-bit form without shifting, as illustrated in FIG. 8. The values of the upper 8 bits 840 among the 16-bit LSB block (840 and 850) are 0. The second similarity between the query vector 810 and the 16-bit LSB block (840, 850) may be calculated.

Meanwhile, the MSB block 820 of the node vector and the LSB block 850 of the node vector may be in a state where information of the LSB block 850 is reflected to the MSB block 820 (i.e., a rounded state). Specifically, when an MSB 851 of the LSB block 850 is 1, information of the MSB 851 of the LSB block 850 may be rounded to an LSB 821 of the MSB block 820. To compensate for this rounded information, 2⁸ may be subtracted from the LSB block 850, and then the second similarity with the query vector 810 may be calculated. Because no information has been rounded to the LSB 821 of the MSB block 820 when the MSB 851 of the LSB block 850 is 0, the similarity with the query vector 810 may be calculated by using the 8 bits of the LSB block 850 as is.

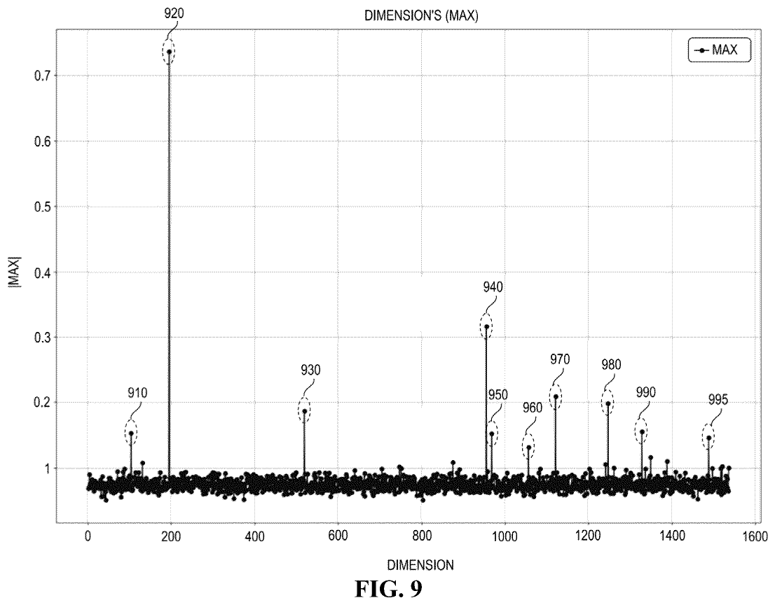

FIG. 9 is a graph showing the absolute maximum value of data in each dimension in a large high-dimensional dataset. The x-axis of the graph represents the dimension of the data, and the y-axis of the graph represents the absolute maximum value |max| of the data value in the corresponding dimension.

Referring to the graph in FIG. 9, it may be seen that some dimensions 910 to 995 have larger absolute maximum values than other dimensions through checking data of each dimension in a large dataset. When a specific dimension has a large absolute maximum value, pieces of data of the corresponding dimension is likely to be relatively larger or more important than pieces of data of other dimensions. The reason is that a dimension with a larger value has a greater impact on the calculation results when data is compared or a distance is calculated. Accordingly, in the graph in FIG. 9, it may be identified that even in a large dataset, calculations for a few specific dimensions 920, 940, and 970 are highly important in the overall search process.

Considering this trend, the vector search method according to an embodiment of the present disclosure may prioritize search precision in calculations on preset important dimensions to search for both an MSB block and an LSB block and may prioritize search speed over search precision in calculations on the remaining dimensions to search for only the MSB block.

In particular, in the embodiment, because searching for only the MSB block for most dimensions is performed, it may adopt a structure that extends the MSB block by the number of important dimensions and records information of the LSB block of an important dimension in the extended MSB block. When such a vector storage structure is applied, search precision may be maintained by searching for only the extended MSB block.

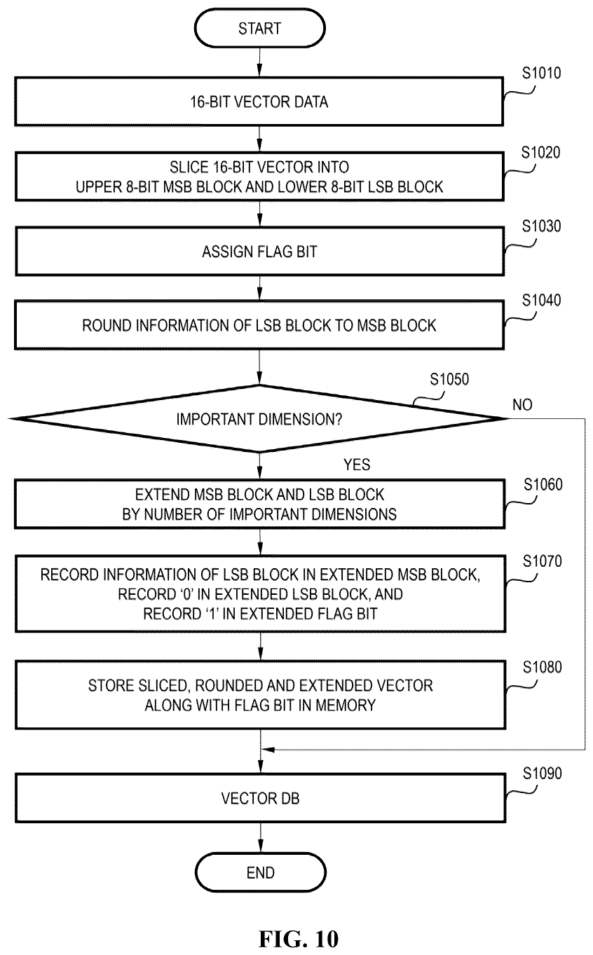

FIG. 10 is a flowchart illustrating a method for storing 16-bit vector data for each dimension, according to an embodiment of the present disclosure.

In the example of FIG. 10, a vector DB system according to an embodiment of the present disclosure may receive a 16-bit vector data (S1010) and may slice the 16-bit vector into an upper 8-bit MSB block and a lower 8-bit LSB block for each dimension (S1020).

In this case, because the MSB block is capable of being extended by the number of important dimensions requiring precise search, a flag bit may be assigned to distinguish original data from the extended data. For example, the flag bit of the original data may not record a value, while the flag bit of the extended data may record a value (S1030). Here, the fact that no value is recorded in the flag bit means that 0 is recorded in the flag bit. Conversely, the fact that a value is recorded in the flag bit means that 1 is recorded in the flag bit.

In the meantime, simply discarding the lower 8 bits and using only the upper 8 bits to increase the speed of vector search may result in errors due to information loss. To prevent this, the vector DB system may improve the accuracy of a search by reflecting information of the LSB block to the MSB block through rounding (S1040).

The rounding is a method for adjusting the MSB block in consideration of information of the LSB block. Even when only the MSB block is used during a vector search by minimizing information loss through the rounding, a closer approximate value of the full value of the 16-bit vector may be obtained.

Meanwhile, the vector DB system determines whether the dimension of the sliced and rounded vector is an important dimension (S1050). Based on the determination result, the vector DB system records information of the LSB block for the important dimension in the MSB block.

To this end, the vector DB system may extend the MSB block and the LSB block by the number of important dimensions (S1060).

Afterwards, the vector DB system records information of the LSB block of the important dimension in the extended MSB block, records ‘0’ in the extended LSB block, and records ‘1’ in the extended flag bit, thereby distinguishing the extended MSB block and LSB block from the original data (S1070).

Afterwards, the vector DB system may store the extended vector, which is sliced, in which information of the LSB block is rounded, and in which information of the LSB block of the important dimension is recorded, in a memory along with the flag bit (S1080). In particular, the vector DB system may store, in the memory, an MSB block, which is sliced and in which information of the LSB block is rounded, an extended MSB block which is sliced and in which information of the LSB block of an important dimension is recorded, a sliced LSB block, and an extended LSB block in which 0 is recorded, along with a flag bit.

In the meantime, the information in the LSB block of the important dimension is changed to 0. Moreover, the LSB block may be extended by the number of important dimensions, but no data is recorded in the extended LSB block. The reason for not recording data in the extended LSB block is to prevent duplication of operations.

As described above, the vector DB system may configure a vector DB by storing, in the memory, an extended vector including an extended MSB block and an extended LSB block for the important dimension (S1090).

When it is configured as in the embodiment of FIG. 10, the MSB block and the LSB block do not need to use a continuous memory space, and each block may be stored separately in the memory. That is, in the embodiment, the memory addresses of the MSB block and the memory addresses of the LSB block may be separated from each other.

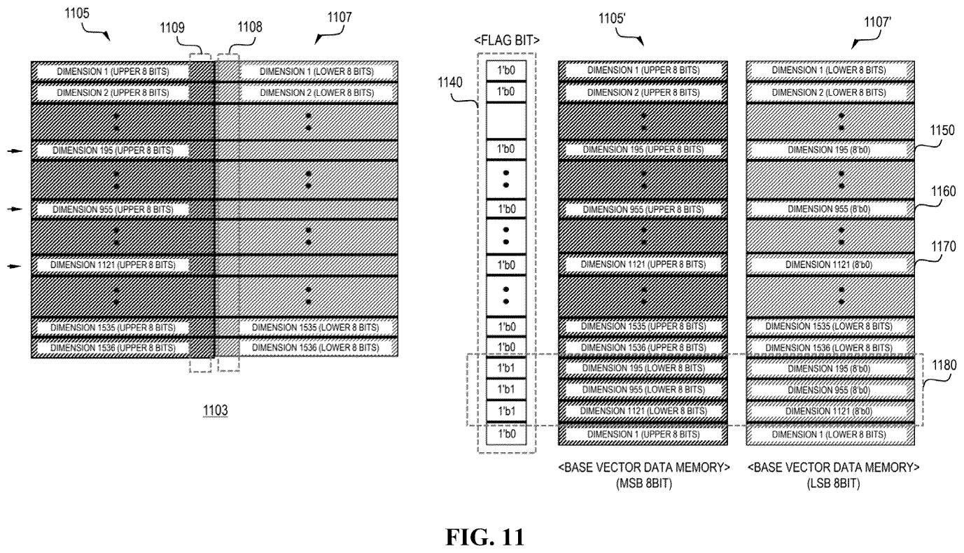

FIG. 11 is a diagram for describing an example of storing 16-bit vector data by reflecting the importance of a dimension, according to an embodiment of the present disclosure.

In the example of FIG. 11, a 16-b it vector 1103 may be sliced for each dimension. For example, the upper 8 bits may be sliced into a MSB block 1105 and the lower 8 bits may be sliced into a LSB block 1107. In the LSB block 1107, a MSB 1108 may include the most information, and the information in the MSB 1108 may be reflected to a LSB 1109 in the MSB block 1105. For example, the information in the LSB block 1107 may be rounded to the MSB block 1105 by adding the value of the MSB 1108 in the LSB block 1107 to the LSB 1109 in the MSB block 1105. In particular, when the value of the MSB 1108 of the LSB block 1107 is 1, 1 is added to the LSB 1109 of the MSB block 1105. When the value of the MSB 1108 of the LSB block 1107 is 0, the value of the LSB 1109 of the MSB block 1105 will not be changed.

In the meantime, in the example of FIG. 11, when dimension 195, dimension 955, and dimension 1121 are important dimensions, the MSB block 1105 and the LSB block 1107 are extended by the number of these important dimensions, and information of the LSB block 1107 of the important dimensions is recorded in the extended MSB block. Referring to blocks 1105′ and 1107′ shown on the right side of FIG. 11, it may be seen that the MSB block and LSB block are extended by the number of important dimensions compared to the original blocks 1105 and 1107. It may be seen that information of LSB blocks 1150, 1160, and 1170 of the important dimension is recorded in the MSB block among extended blocks 1180. It may be seen that the value of the LSB blocks 1150, 1160, and 1170 of the important dimension is changed to 0(8′b0). Moreover, it may be seen that a value is not recorded in the LSB block among the extended blocks 1180 (8′b0). This is to prevent duplication of operations.

Furthermore, in the example of FIG. 11, a flag bit 1140 may be assigned to distinguish the original blocks 1105 and 1107 from the extended blocks 1180. In the case, a value is not recorded in the flag bit of the original blocks 1105 and 1107 (1′b0), but a value is recorded in the flag bit of the extended blocks 1180 (1′b1). Here, the fact that a value is not recorded in the flag bit means that the flag bit is 0. The fact that a value is recorded in the flag bit means that the flag bit is 1.

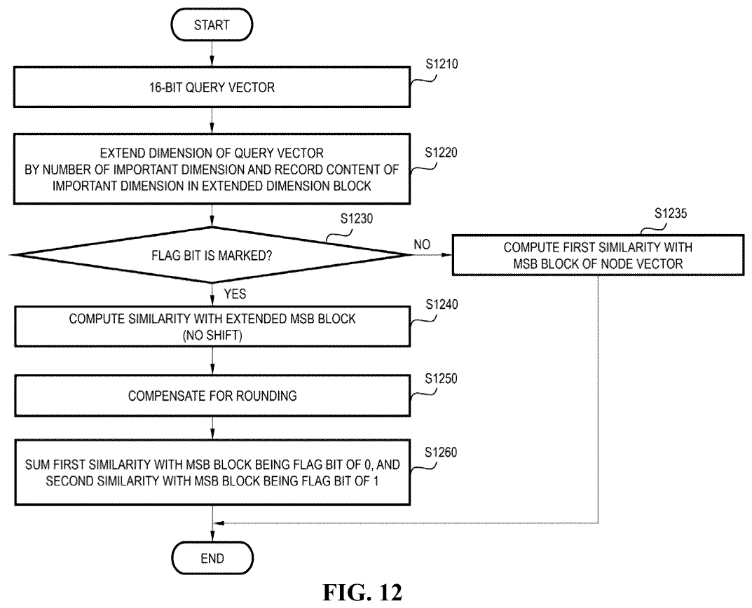

FIG. 12 is a flowchart illustrating a method for performing a lightweight vector search by reflecting the importance of a dimension in a vector DB system, according to an embodiment of the present disclosure.

When a 16-bit query vector is received by a vector DB system according to an embodiment of the present disclosure (S1210), the vector DB system may extend the dimensions of the query vector by the number of important dimensions and may record the content of the important dimension in the extended dimension block (S1220). This is done to synchronize the computation timing between a node vector and a query vector, because the node vector is stored in a memory in a form extended by reflecting the importance of the dimension.

Afterwards, the vector DB system may determine whether a flag bit of the node vector stored in the memory is marked (S1230), and may calculate the similarity between the query vector and the node vector by using different methods depending on the determination result. Here, the fact that the flag bit is marked means that the flag bit is 1. The fact that the flag bit is not marked means that the flag bit is 0.

When the determination result of S1230 indicates that the flag bit is not marked (S1230, NO) (i.e., the flag bit is 0), the vector DB system prioritizes search speed to compute the similarity between the query vector and the node vector. In particular, because most dimensions among dimensions with a flag bit of 0 are not important, the vector DB system may compute only the first similarity between the query vector and the MSB block of the node vector (S1235) and return the first similarity as the similarity calculation result. In this way, the vector DB system may reduce the computational burden and may increase the speed of the vector search.

In the case, because the MSB block of the dimension with a flag bit of 0 corresponds to the upper 8 bits of the node vector, the vector DB system may shift the MSB block to the left by 8 bits to convert it to a 16-bit format and may calculate the first similarity between this 16-bit MSB block and the query vector. In this case, because the values of the lower 8 bits of the 16-bit MSB block are 0, the vector DB system may calculate the first similarity with the query vector by using only information of the upper 8 bits of the 16-bit MSB block that is not an important dimension (S1235). Moreover, the calculation result may be returned as the similarity calculation result.

When the determination result of S1230 indicates that the flag bit is marked (S1230, YES) (i.e., the flag bit is 1), the vector DB system prioritizes search precision and then computes the similarity between the query vector and the node vector. In detail, because a dimension with a flag bit of 1 is an important dimension, similarity may be calculated by further reflecting information of the LSB block of the important dimension.

A node vector according to an embodiment of the present disclosure stores information of an LSB block of an important dimension in an extended MSB block with respect to an important dimension, and a flag bit is marked in the extended block. Accordingly, because the MSB block with the marked flag bit refers to information of the LSB block of the important dimension, and the information of the LSB block of the important dimension corresponds to the lower 8 bits of the node vector, the vector DB system may convert the MSB block with the marked flag bit into a 16-bit format without shifting and may calculate the second similarity between the query vector and this 16-bit MSB block (S1240).

In the meantime, while slicing the node vector into MSB and LSB blocks, the vector DB system may store the information of the LSB block in a rounded format obtained by reflecting the MSB block. In this case, in a precise search of calculating the similarity between the query vector and the LSB block, it is necessary to compensate for the rounded information (S1250).

For example, when the MSB of the LSB block is 1, the vector DB system may reflect and store the corresponding information to the LSB of the MSB block. Accordingly, in the case of a precise search that calculates the second similarity between the query vector and an extended MSB block, which has a flag bit of 1 and where the LSB information of the important dimension is stored, when the MSB of the extended MSB block is 1, this indicates that rounded information is present. As a result, the second similarity with the query vector may be calculated by subtracting 2⁸ from the extended MSB block. When the MSB of the extended MSB block is 0, this indicates that the rounded information is not present. Therefore, the second similarity with the query vector may be calculated by using the 8-bit extended MSB block as is.

Afterwards, with respect to important dimensions where a precise search is important, the vector DB system may sum the first similarity between the query vector and the MSB block of the node vector with the flag bit of 0, and the second similarity between the query vector and the MSB block of the node vector with the flag bit of 1 (S1260 ). Moreover, the sum result may be returned as the similarity calculation result.

Meanwhile, as described above in S1235, with respect to most dimensions, which are not important dimensions, from among dimensions with the flag bit of 0, the vector DB system may compute only the first similarity between the query vector and the MSB block of the node vector (S1235). Moreover, the calculation result may be returned as the similarity calculation result.

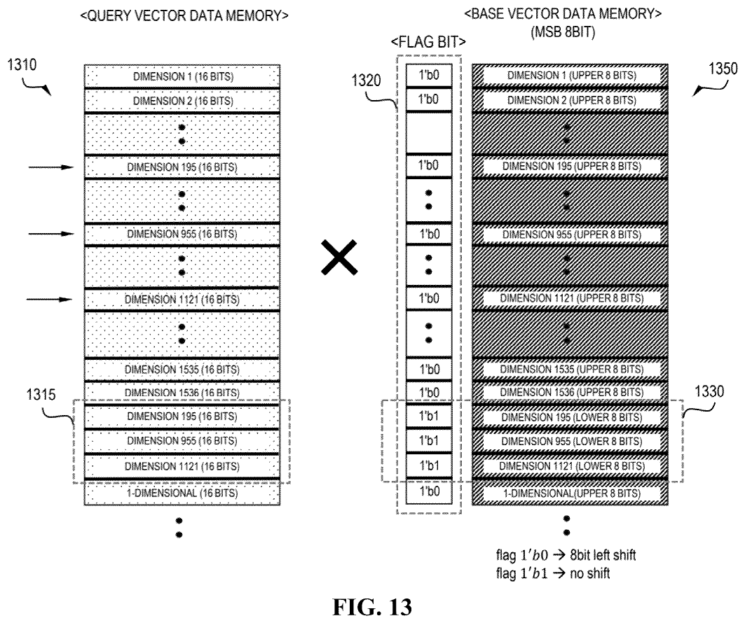

FIG. 13 is a diagram illustrating an example of a vector search light-weighted by reflecting importance of a dimension, according to an embodiment of the present disclosure.

In the example of FIG. 13, when a 16-bit query vector 1310 is received by the vector DB system, blocks of the query vector 1310 extends by the number of blocks corresponding to the number of important dimensions (e.g., dimension 195, dimension 955, and dimension 1121). The data value of the important dimension may be recorded in extended blocks 1315. This is done to synchronize the computation timing between a node vector and the query vector 1310, because the node vector is stored in a memory in a form extended by reflecting the importance of the dimension.

Afterwards, the vector DB system calculates the similarity between the query vector and the node vector for each dimension. In particular, because most dimensions among dimensions with a flag bit 1320 of 0 are not important dimensions in the node vector, the vector DB system calculates only the similarity between the query vector and a MSB block 1350 of the node vector. In this way, the vector DB system may reduce the computational burden and may increase the speed of the vector search. Because the MSB block with a flag bit of 0 corresponds to the upper 8 bits of the node vector, the MSB block is shifted by 8 bits to the left and is converted to a 16-bit format. In this case, the values of the lower 8 bits of the 16-bit MSB block become 0. The first similarity between the query vector 1310 and the 16-bit MSB block may be calculated.

However, the similarity between the query vector and the LSB block of the node vector needs to be reflected to a search for an important dimension requiring a precise search. A node vector according to an embodiment of the present disclosure stores information of an LSB block of an important dimension in an extended MSB block 1330 with respect to an important dimension, and a flag bit is marked in the extended block 1330. Because the MSB block 1330 with the marked flag bit corresponds to the lower 8 bits of the node vector, the MSB block 1330 with the marked flag bit is converted to a 16-bit format without shifting. In this case, the values of the upper 8 bits of the 16-bit MSB block become 0. The second similarity between the query vector 1310 and the 16-bit MSB block may be calculated.

Meanwhile, the extended MSB block 1330 stores information of the LSB block of the important dimension, but some of the information may already be rounded. In detail, when the MSB of the extended MSB block 1330 is 1, this indicates that the rounded information is present. Accordingly, the second similarity with the query vector may be calculated by subtracting 2⁸ from the extended MSB block 1330. When the MSB of the extended MSB block 1330 is 0, this indicates that the rounded information is not present. Therefore, the second similarity with the query vector may be calculated by using the 8-bit extended MSB block 1330 as is.

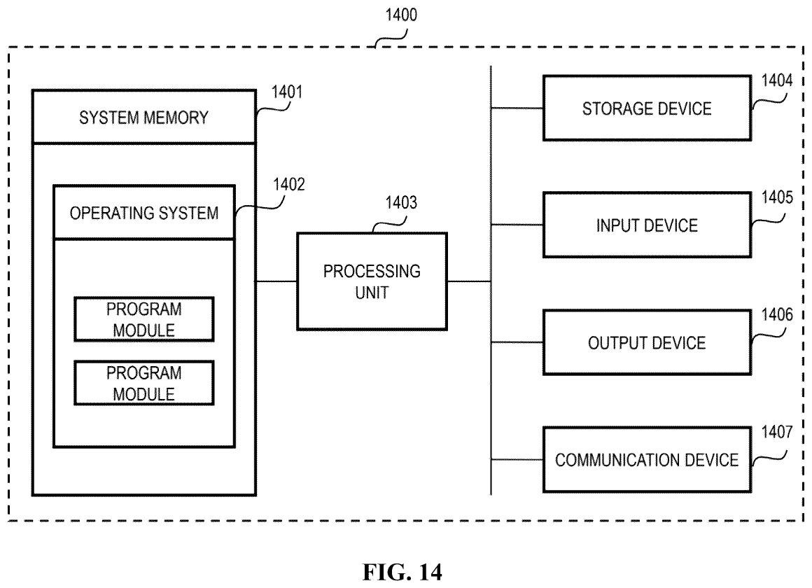

FIG. 14 is a diagram for describing a computing operating environment of a server providing a vector DB system, according to one embodiment of the present disclosure.

FIG. 14 is designed to provide a general and simplified description of a suitable computing environment in which embodiments of a system server are capable of being implemented. Referring to FIG. 14, a computing apparatus 1400 is illustrated as an example of the system server.

The computing device 1400 may include at least a processing unit 1403 and a system memory 1401.

The computing device 1400 may also include a plurality of processing units that cooperate in executing a program.

Depending on the exact configuration and type of the computing device 1400, a system memory 1401 may be volatile memory (e.g., RAM), nonvolatile memory (e.g., ROM, flash memory, etc.), or a combination thereof. The system memory 1401 includes a suitable operating system 1402 for controlling the operation of the platform, such as the WINDOWS operating system from Microsoft Corporation. The system memory 1401 may include one or more software applications, such as program modules or applications.

The computing device 1400 may include additional data storage devices 1404, such as magnetic disks, optical disks, or tapes. Such additional storage device 1404 may be removable storage and/or fixed storage. Computer-readable storage media may include volatile and non-volatile media and removable and stationary media that are implemented for storing information, such as computer-readable instructions, data structures, program modules, or other data, using any method or technique.

Both the system memory 1401 and the storage device 1404 are all examples of computer-readable storage media. The computer-readable storage media may include, but is are not limited to, memory devices such as a random access memory (RAM), a read-only memory (ROM), an electrically erasable programmable read-only memory (EEPROM), a flash memory, and others, optical storages such as a compact disc read only memory (CD-ROM), a digital versatile disk (DVD) or other optical storage, magnetic tape, magnetic disk storage, and others, and any other medium capable of storing desired information and being accessed by the computing device 1400.

An input device 1405 of the computing device 1400 may include, for example, a keyboard, a mouse, a pen, a voice input device, a touch input device, and comparable input devices. The input device 1405 is well known in the art, and therefore, a detailed description thereof will be omitted.

An output device 1406 of the computing device 1400 may include, for example, a display, a speaker, a printer, and other types of output devices. The output device 1406 is well known in the art, and therefore, a detailed description thereof will be omitted.

The computing device 1400 may also include a communication device 1407 that allows the computing device 1400 to communicate with other devices over, for example, a distributed computing environment network, such as a wired or wireless network, a satellite link, a cellular link, or a short-range network, using comparative mechanism. The communication device 1407 is one example of a communication medium, which may include computer-readable instructions, data structures, program modules, or other data therein. Examples of the communication medium may include, but is not limited to, wired media such as a wired network and direct-wired connection, and wireless media such as acoustic, a radio frequency (RF), infrared rays, and others.

Methods according to various embodiments of the present application may be implemented in a form of program instructions that may be executed through various computing devices and may be recorded in a computer-readable recording medium. The computer-readable recording medium may include program instructions, data files, data structures or the like, alone or a combination thereof. The program instructions recorded in the computer-readable recording medium may be specially designed and configured for the embodiments or be known to those skilled in a field of computer software. Examples of the computer-readable recording medium may include a magnetic media such as a hard disk, a floppy disk, or a magnetic tape; an optical medium such as a compact disk read only memory (CD-ROM) or a digital versatile disk (DVD); a magneto-optical medium such as a floptical disk; and a hardware device specially configured to store and execute program commands, such as a ROM, a random access memory (RAM), a flash memory, or the like. Examples of the program instructions include high-level language codes capable of being executed by a computer using an interpreter or the like, as well as machine language codes made by a compiler. The above-described hardware device may be constituted to be operated as one or more software modules to perform the operations of the embodiments, and vice versa.

According to an embodiment of the present disclosure, the efficiency of a vector DB system may be enhanced by reducing search resources and maintaining the precision of vector search at the same time.

Effects of the present disclosure are not limited to the above-described effects, and any other effects not mentioned herein may be clearly understood from this specification and the accompanying drawings by those skilled in the art to which the present disclosure pertains.

Embodiments have been described hereinabove by restrictive examples and drawings, but various modifications and variations may be made from the above description by those skilled in the art. For example, even though the described technologies are performed in an order different from that of the described method, and/or components of the described system, structure, device, circuit, and the like may be coupled to or combined with each other in a form different from that of the described method, or are replaced by other components or their equivalents, appropriate results may be achieved.

Therefore, other implementations, other embodiments, and equivalents of the claims fall within the scope of the following claims.

What is claimed is:

1. A method of storing a vector in a server providing a vector database (DB) system, the method comprising:
slicing a 16-bit vector into an upper 8-bit More Significant Bits (MSB) block and a lower 8-bit Less Significant Bits (LSB) block;
rounding the MSB block by reflecting information of the LSB block to the MSB block; and
storing the rounded MSB block and the LSB block.

2. The method of claim 1, wherein the rounding of the MSB block includes:
summing a value of Most Significant Bit (MSB) of the LSB block to a Least Significant Bit (LSB) of the MSB block.

3. The method of claim 1, further comprising:
assigning a flag bit to each dimension of the LSB block and the rounded MSB block;
extending the MSB block by a preset number of an important dimension, extending the flag bit by a number of the important dimension, and marking the extended flag bit;
recording information of a LSB block of the important dimension in the extended MSB block; and
storing the extended MSB block and the marked flag bit.

4. The method of claim 3, further comprising:
extending the LSB block by the preset number of the important dimension; and
storing the extended LSB block,
wherein memory address spaces of the MSB block and the LSB block are separated from each other.

5. A method of calculating a vector in a server providing a vector DB system, the method comprising:
when a 16-bit query vector is received, searching for a candidate node similar to the query vector in a pre-stored vector index;
calculating first similarity between the query vector and an upper 8-bit MSB block of the candidate node; and
returning the first similarity as similarity of a candidate node after a predetermined number of hops in the vector index.

6. The method of claim 5, further comprising:
calculating second similarity between the query vector and a lower 8-bit LSB block of the candidate node; and
returning a result of summing the first similarity and the second similarity as similarity between the query vector and a candidate node before a predetermined number of hops in the vector index.

7. The method of claim 6, wherein the calculating of the second similarity includes:
when an MSB of the LSB block is 1, subtracting 2⁸ from the LSB block and calculating the second similarity with the query vector.

8. A method of calculating a vector in a server providing a vector DB system, the method comprising:
when a 16-bit query vector is received, extending a dimension of the query vector by a preset number of an important dimension and recording content of the important dimension in an extended dimension block; and
calculating first similarity between the query vector and an upper 8-bit MSB block of a candidate node with respect to a dimension, of which a flag bit is not marked, from among dimensions of the candidate node.

9. The method of claim 8, further comprising:
calculating second similarity between an extended query vector and an extended MSB block of the candidate node with respect to a dimension, in which a flag bit is marked, from among the dimensions of the candidate node;
summing the first similarity and the second similarity in the important dimension; and
returning the sum result as similarity of the candidate node.

10. A vector storage apparatus in a vector DB system, the vector storage apparatus comprising:
a processing unit configured to slice a 16-bit vector into an upper 8-bit MSB block and a lower 8-bit LSB block and to round the MSB block by reflecting information of the LSB block to the MSB block; and
a memory configured to store the rounded MSB block and the LSB block.

11. An apparatus calculating a vector in a vector DB system, the apparatus comprising:
a control unit configured to schedule, when a 16-bit query vector is received, a search task for a candidate node similar to the query vector from a pre-stored vector index; and
a vector processing unit configured to calculate first similarity between the query vector and an upper 8-bit MSB block of the candidate node, and to return the first similarity as similarity of a candidate node after a predetermined number of hops in the vector index.

12. An apparatus calculating a vector in a vector DB system, the apparatus comprising:
a control unit configured to extend, when a 16-bit query vector is received, a dimension of the query vector by a preset number of an important dimension and to record content of the important dimension in an extended dimension block; and
a vector processing unit configured to calculate first similarity between the query vector and an upper 8-bit MSB block of a candidate node with respect to a dimension, in which a flag bit is not marked, from among dimensions of the candidate node.
